(19) United States
(12) Patent Application Publication
(10) Pub. No.: US 2003/0228803 A1
(43) Pub. Date: Dec. 11, 2003

(54) Outlet system accommodating enlarged plugs

(76) Inventor: Robert Jay Toering, San Pedro, CA (US)

Correspondence Address: Robert J. Toering, Suite 408, 514 W. 26th Street, San Pedro, CA, 90731, US

(21) Appl. No.: 10/165,918

(22) Filed: Jun. 10, 2002

(51) Int. Cl. H01R 25/00

(52) U.S. Cl. 439/652

(57) ABSTRACT

A power receptacle system is provided for allowing the connection with a multiple number of enlarged plugs. The system includes a main power cord and a central housing with a plurality of outlets flexibly connected to the central housing. Each of the outlets is free to move relative to the central housing and the other outlets. Therefore, the spacing between outlets is adjustable, allowing oversized plugs to be connected to adjacent outlets without physical interference.

### BACKGROUND OF THE INVENTION

1. Field of the Invention

The present invention relates to electrical outlets and more particularly pertains to a new multiple outlet system for accepting a plurality of enlarged plugs.

2. Description of the Prior Art

The use of outlets is well known in prior art. More specifically, multiple outlet systems heretofore devised and utilized are known to consist basically of familiar, expected and obvious structural configurations. Known prior art outlet systems include U.S. Pat. No. 3,439,315; U.S. Pat. No. 4,017,137; U.S. Pat. No. 4,113,334; U.S. Pat. No. 4,493,515; U.S. Pat. No. 4,705,342; U.S. Pat. Des. 356,294; and U.S. Pat. Des. 382,855. Prior art specifically addressing the issue of the acceptance of multiple enlarged plugs also employ the same familiar, expected and obvious structural configurations. Known prior art regarding the acceptance of multiple enlarged plugs include U.S. Pat. No. 4,867,701; U.S. Pat. No. 5,848,915; and U.S. Pat. No. 6,113,434.

Prior art specifically devoted to the issue of oversized plugs has addressed the issue by specifying greater spacing between one or more pairs of rigidly positioned outlets. Since transformers and converters are produced in a wide variety of shapes and sizes, allowing for their use by varying the spacing of rigidly positioned outlets is, at best, inefficient. Furthermore, the trend in recent years has been for more and more computer peripherals to utilize transformers and converters rather than conventional grounded plugs. As a result, a typical home or small office computer instillation may involve seven or eight plugs to power all of the components, with five or six of them being transformers or converters.

In these respects, the outlet system accommodating enlarged plugs according to the present invention substantially departs from the conventional concepts and designs of the prior art, and in so doing provides a apparatus primarily developed for the purpose of allowing a plurality of transformer plugs to be plugged into a single outlet system.

### BRIEF SUMMARY OF THE INVENTION

The present invention provides an electrical outlet system generally comprising a plurality of single “female” outlets flexibly connected to a single power source. The placement of the individual outlet connections is such as to allow the space between adjacent outlets to adjust to accommodate a multitude of large transformer type plugs to be inserted into outlets.

Each single “female” outlet of the outlet system of the present invention is preferably adapted to accept a three-pronged plug, the outlet including two elongated prong-receiving apertures and a ground prong-receiving aperture.

The outlet system of the present invention includes a power cord equipped with a three-pronged plug for electronically connected to the central power source. The power cord and the plurality of “female” outlets are electronically connected within a central housing. The electronic connections within that housing will typically include built-in circuit protection and power interruption features.

### BRIEF DESCRIPTION OF THE DRAWINGS

FIG. 1 is a perspective view of a preferred embodiment of the power receptacle system of the present invention.

FIG. 2 is a perspective view of another preferred embodiment of the power receptacle system of the present invention.

FIG. 3 is a perspective view from a different angle of the preferred embodiment of the power receptacle system of the present invention as illustrated in FIG. 2.

FIG. 4 is a perspective view from a different angle of the preferred embodiment of the power receptacle system of the present invention as illustrated in FIG. 2, with the flexible connecting members in a relaxed state.

FIG. 5 is a perspective view of a portion of a preferred embodiment of the power receptacle system as in FIG. 3, with some of the flexible connecting members flexed.

FIG. 6 is a perspective view of yet another preferred embodiment of the power receptacle system of the present invention.

### DETAILED DESCRIPTION OF THE INVENTION

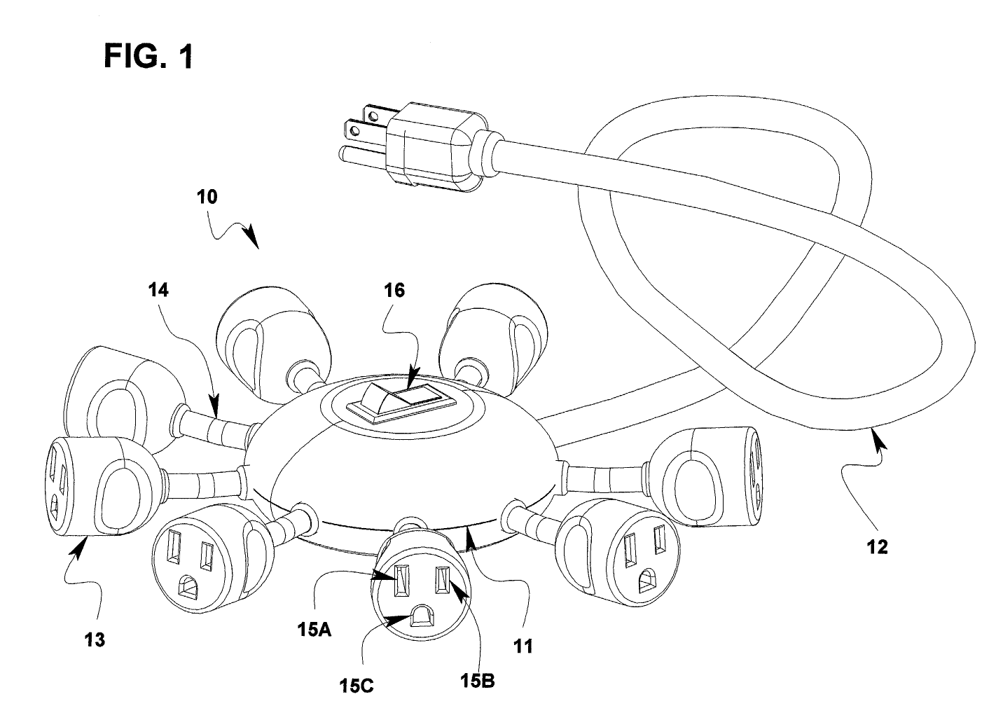

Referring now to FIG. 1, an electrical power receptacle system of the present invention is shown and indicated generally by the number 10. The power receptacle system 10 generally comprises a central insulated housing 11 with an attached power cord 12 extending from the central insulated housing 11 to an electrical power source. As shown in FIG. 1, a plurality of “female” outlets 13 are attached to the central insulated housing 11 by flexible connecting members 14. Each of the “female” outlets 13 provides provisions for electrical connection, having two elongated apertures 1 5A and 1 5B adapted for the receipt of a pronged plug having prongs of different polarities. Each “female” outlet 13 also preferably includes an aperture 15C adapted for receipt of the ground prong of the plug. The central insulated housing 11 incorporates an on/off switch 16 to allow power flow to the “female” outlets 13 to be interrupted. Likewise, the central insulated housing 11 may contain overload circuit breakers, surge protection devices, and battery back-up units as additional system features.

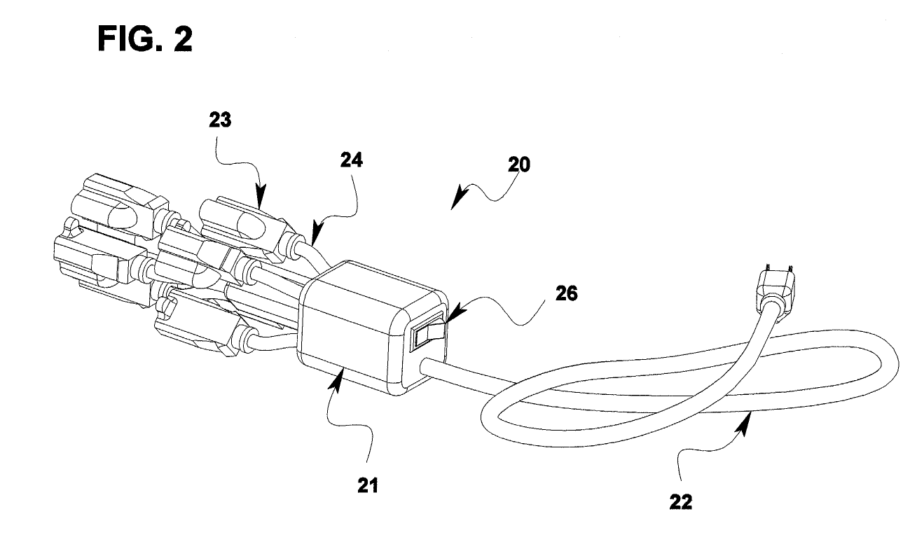

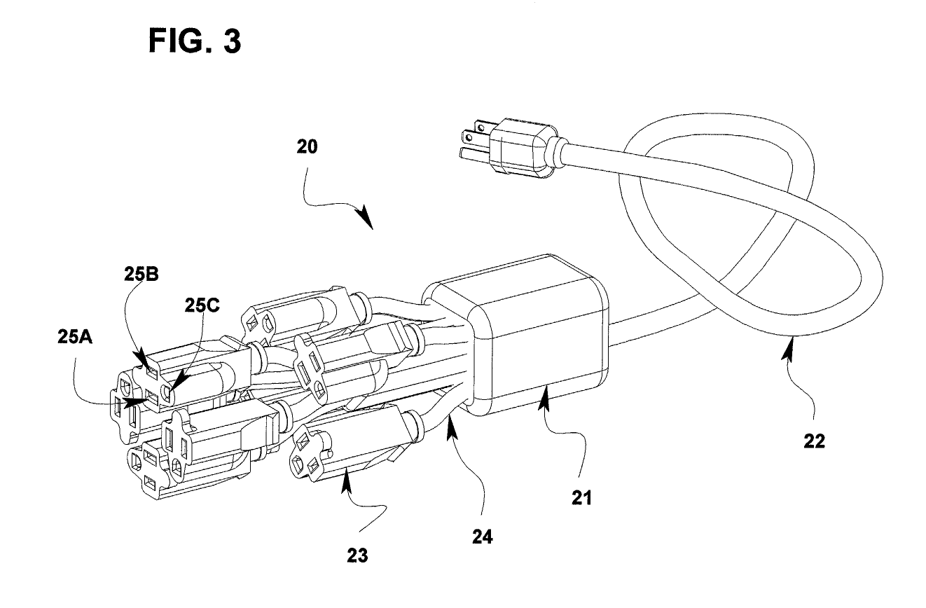

The radial arrangement of “female” outlets 13, as depicted in FIG. 1, is a possible geometry for a preferred embodiment of the present invention. Referring to FIG. 2, another preferred embodiment of electrical power receptacle system of the present invention is shown and indicated generally by the number 20. The power receptacle system 20 generally comprises a central insulated housing 21 with an attached power cord 22 extending from the central insulated housing 21 to an electrical power source. As shown in FIG. 3, a plurality of “female” outlets 23 are attached to the central insulated housing 21 by flexible connecting members 24. Each of the “female” outlets 23 provides provisions for electrical connection, having two elongated apertures 25A and 25B adapted for the receipt of a pronged plug having prongs of different polarities. Each “female” outlet 23 also preferably includes an aperture 25C adapted for receipt of the ground prong of the plug. As shown in FIG. 2, the central insulated housing 21 incorporates an on/off switch 26 to allow power flow to the “female” outlets 23 to be interrupted. Likewise, the central housing 21 may contain overload circuit breakers, surge protection devices, and battery back-up units as additional system features.

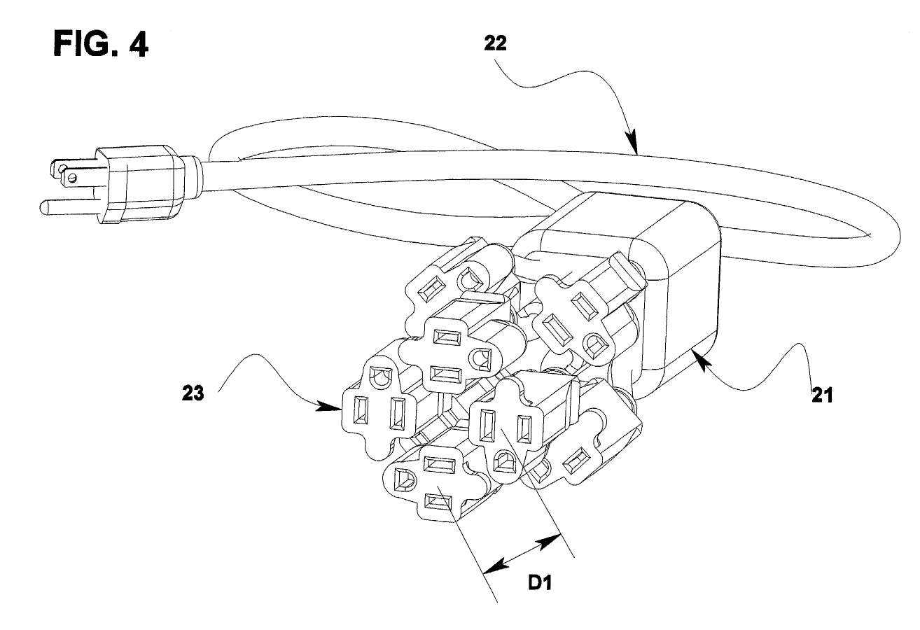

Referring to FIG. 4, the distance D1 between adjacent “female” outlets 13 when the flexible connecting members 14 are in the relaxed or unflexed position may not be sufficient to prevent interference between oversized plugs. Oversized plugs is a general term to collectively include transformers, adapters, chargers, and other “male” plug units with body dimensions that are larger than the typical grounded three-pronged plug.

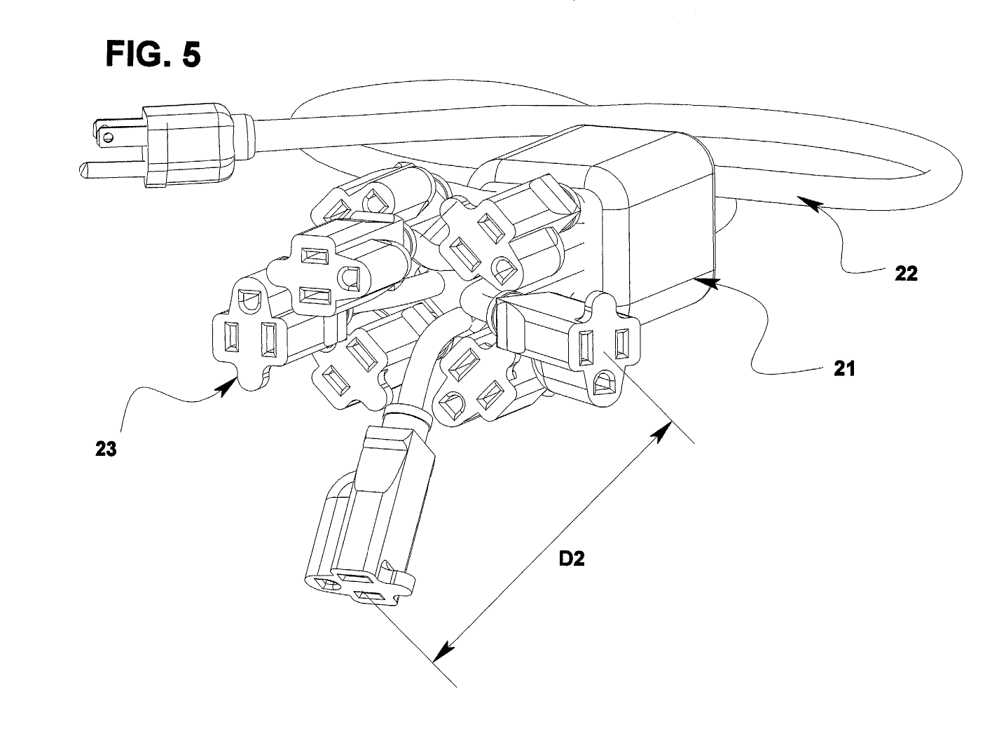

However, referring to FIG. 5, when the flexible connecting members 14 are flexed to expand the distance between adjacent “female” outlets 13, the distance expands to D2, which is sufficient to prevent interference between oversized plugs. Since the flexible connecting members 14 are free to flex in any required direction, the clearance between all of the adjacent “female” outlets 13 can be expanded to prevent interference.

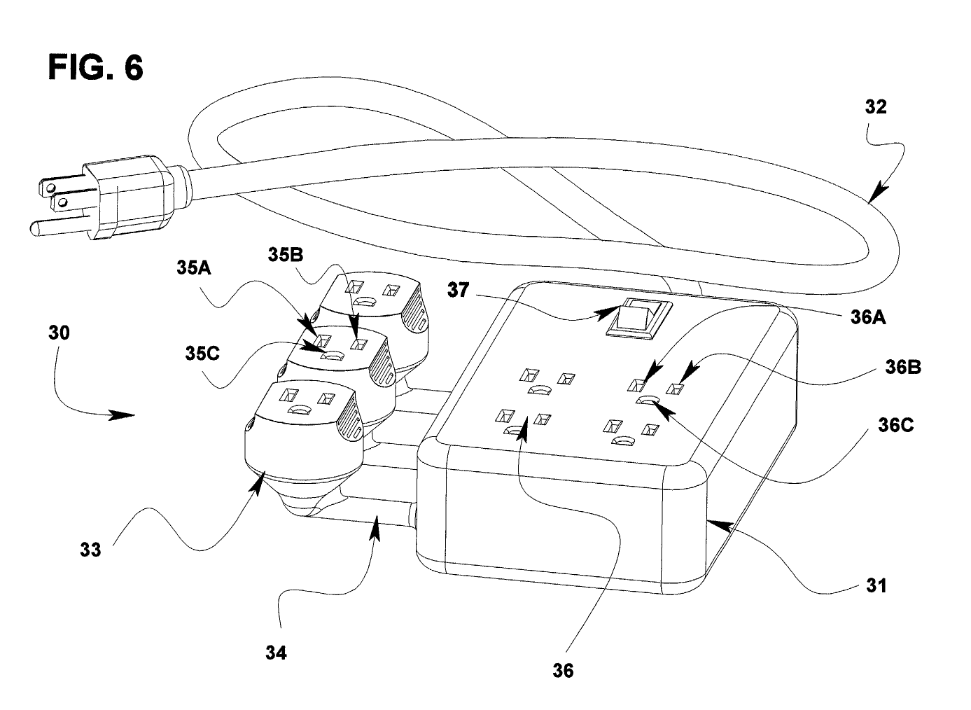

Referring now to FIG. 6, another preferred embodiment of the electrical power receptacle system of the present invention is shown and indicated generally by the number 30. The power receptacle system 30 generally comprises a central insulated housing 31 with an attached power cord 32 extending from the central insulated housing 31 to an electrical power source. As shown in FIG. 6, a plurality of “female” outlets 33 are attached to the central insulated housing 31 by flexible connecting members 34. Each of the “female” outlets 33 provides provisions for electrical connection, having two elongated apertures 35A and 35B adapted for the receipt of a pronged plug having prongs of different polarities. Each “female” outlet 33 also preferably includes an aperture 35C adapted for receipt of the ground prong of the plug. The central insulated housing 31 incorporates a a plurality of “fixed female” outlets 36. Each of the “fixed female” outlets 36 provides provisions for electrical connection, having two elongated apertures 36A and 36B adapted for the receipt of a pronged plug having prongs of different polarities. Each “fixed female” outlet 36 also preferably includes an aperture 36C adapted for receipt of the ground prong of the plug. The central insulated housing 31 also incorporates an on/off switch 37 to allow power flow to the “female” outlets 33 and the “fixed female” outlets 36 to be interrupted. Likewise, the central insulated housing 31 may contain overload circuit breakers, surge protection devices, and battery back-up units as additional system features.

It should be appreciated that a range of modification, change and substitution is intended in the foregoing disclosure and, in certain instances, some features of the invention will be employed without a corresponding use of other features. Accordingly, it is appropriate that the appended claims be construed broadly and in a manner consistent with the spirit and the scope of the invention herein.

What I claim as my invention is:

1. An electrical outlet system comprising an insulated housing and a power cord equipped with a pronged electrical plug connected to said housing and a plurality of single “female” outlets connected by flexible members to said housing, each said outlet including apertures adapted to receive a pronged electrical plug, wherein the spacing between adjacent said outlets may be increased by flexing said flexible members and moving one said outlet relative to another said outlet.

2. The electrical outlet system of claim 1, wherein the spacing between adjacent said outlets is insufficient to allow oversized plugs to be placed in adjacent said outlets, when said flexible members are “un-flexed”, but when adjacent said outlets are pushed apart the length and flexibility of said flexible members is sufficient to allow the space between adjacent said outlets to lengthen until oversized plugs can be placed in adjacent said outlets.

3. The electrical outlet system of claim 2, wherein the internal wiring circuit contained within said insulated housing includes an on-off power switch to interrupt the flow of current to said outlets.

4. The electrical outlet system of claim 2, wherein the internal wiring circuit contained within said insulated housing includes a circuit breaker to prevent the flow of excessive current through said outlet system.

5. The electrical outlet system of claim 2, wherein the internal wiring circuit contained within said insulated housing includes a battery and charging circuit to temporarily prevent the interruption of electrical flow to said outlets.

6. The electrical outlet system of claim 2, wherein said insulated housing incorporates a plurality of single “fixed female” outlets included in the electrical circuit of the system.

7. The electrical outlet system of claim 2, wherein the internal wiring contained within said insulated housing includes a power surge protection circuit to prevent power spikes from flowing to said outlets.

8. The electrical outlet system of claim 7, wherein said power surge protection circuit also incorporates protection for data lines and said insulated housing includes connection points for said data lines.
